(19) United States
(12) Patent Application Publication
(10) Pub. No.: US 2002/0144008 A1
(43) Pub. Date: Oct. 3, 2002

(54) Instrumenting stack components via layer manager

(76) Inventors: Douglas LaVell Hale, Orem, UT (US); Michael D. Wright, Sandy, UT (US); Merrill Kay Smith, Riverton, UT (US); David O. Cox, Orem, UT (US); Kyle Bryan Seegmiller, Salt Lake City, UT (US); Jonathan Brett Wood, Spanish Fork, UT (US)

Correspondence Address: SAWYER LAW GROUP LLP, P.O. Box 51418, Palo Alto, CA, 94303, US

(21) Appl. No.: 09/825,590

(22) Filed: Apr. 3, 2001

(51) Int. Cl. G06F 9/46

(52) U.S. Cl. 709/313

(57) ABSTRACT

The present invention provides a method and system for instrumenting protocol stack components. The method includes: receiving data from a first stack component of the protocol stack by a layer manager; analyzing the data for instrumentation information by the layer manager; and routing the data to a second stack component of the protocol stack by the layer manager. The system comprises a layer manager which interfaces with each stack component and handles the data flow to the stack components. To instrument the protocol stack, the layer manager is instrumented without the need to instrument the stack, components. In this manner, the instrumentation of the protocol stack is simplified, and the amount of code required to capture and analyze the data is reduced.

### FIELD OF THE INVENTION

The present invention relates to protocol stacks, and more particularly to instrumentation of stack components in the protocol stack.

### BACKGROUND OF THE INVENTION

The Bluetooth™ networking protocol is well known in the art. FIG. 1 illustrates a standard Bluetooth protocol stack. The stack 100 includes a Host Controller Interface (HCI) layer 106, a Logical Link Control and Adaptation Protocol (L2CAP) layer 108, a Telephony Control Protocol Specification (TCS) layer 110, a Service Discovery Protocol (SDP) layer 112, and a RFCOMM protocol layer 114.

The HCI layer 106 provides a command interface which accepts communications over the physical bus (not shown). The L2CAP layer 108 supports higher level protocol multiplexing, packet segmentation and reassembly, and the conveying of quality of service information.

The TCS layer 110 provides call control and signaling of voice channels. The SDP layer 112 provides a means for applications to discover which services are provided by or available through a device. It also allows applications to determine the characteristics of those available services. The RFCOMM protocol layer 114 provides emulation of serial ports over the L2CAP layer 108.

The protocol stack 100 is implemented by a plurality of stack components. A “stack component”, as used in this specification, is software which implements a layer of the protocol stack 100. For purposes of FIG. 1, the blocks representing a layer in the stack 100 also represents a stack component. Instrumentation of the stack components 105-114 is desirable to enable measurement of a stimulus received by a stack component and/or a response of the stack component to a stimulus. The instrumentation provides information which aid in fixing problems, optimizing performance and behavior, gathering utilization statistics, etc. To instrument the stack components 105-114, code must be added to the stack components 105-114 wherever data is available or where information can be gathered.

However, in the conventional protocol stack 100, since the stack components 106-114 communicate with each other through private and unique interfaces, each stack component 106-114 must be instrumented separately. This often results in repetitive, and possibly incompatible, work being done on each interface. The data acquired at each interface may be dissimilar, requiring more processing before analysis.

Accordingly, there exists a need for an improved method and system for instrumenting protocol stack components. The present invention addresses such a need.

### SUMMARY OF THE INVENTION

The present invention provides a method and system for instrumenting protocol stack components. The method includes: receiving data from a first stack component of the protocol stack by a layer manager; analyzing the data for instrumentation information by the layer manager; and routing the data to a second stack component of the protocol stack by the layer manager. The system comprises a layer manager which interfaces with each stack component and handles the data flow to the stack components. To instrument the protocol stack, the layer manager is instrumented without the need to instrument the stack components. In this manner, the instrumentation of the protocol stack is simplified, and the amount of code required to capture and analyze the data is reduced.

### BRIEF DESCRIPTION OF THE FIGURES

FIG. 1 illustrates a standard Bluetooth protocol stack.

FIG. 2 illustrates a preferred embodiment of a protocol stack which provides improved stack component instrumentation in accordance with the present invention.

FIG. 3 is a flowchart illustrating a preferred embodiment of a method for providing stack component instrumentation in accordance with the present invention.

### DETAILED DESCRIPTION

The present invention provides an improved method and system for instrumenting protocol stack components. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

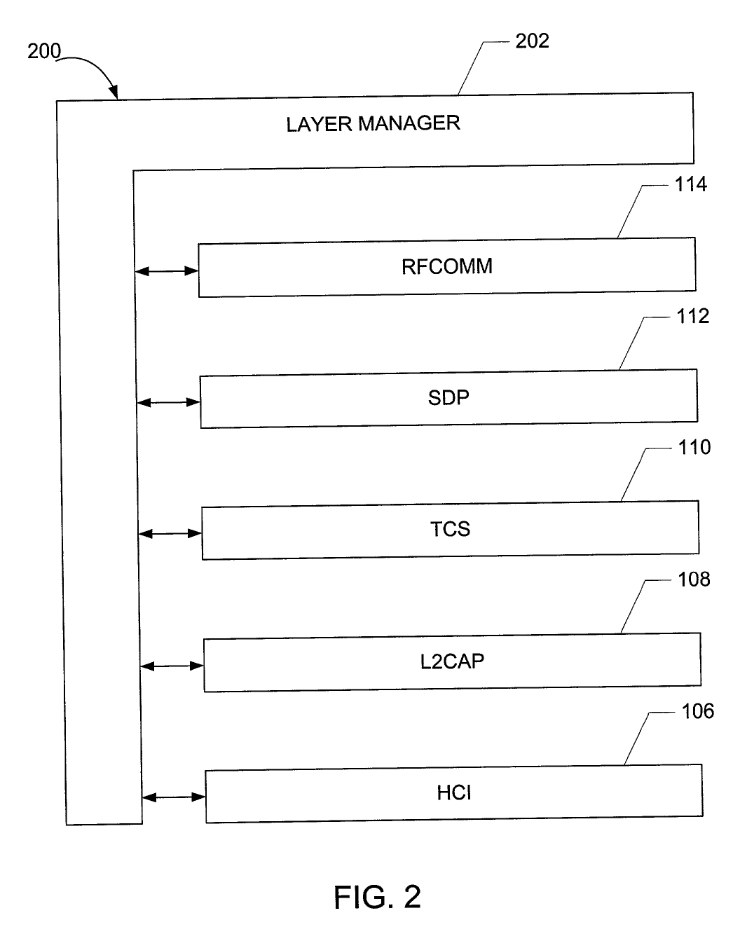

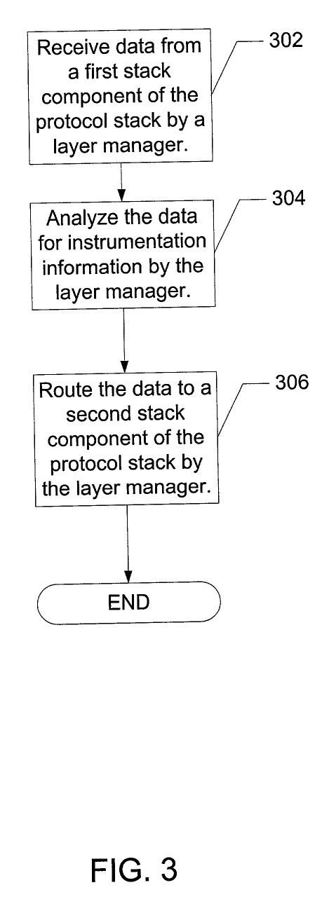

To more particularly describe the features of the present invention, please refer to FIGS. 2 and 3 in conjunction with the discussion below.

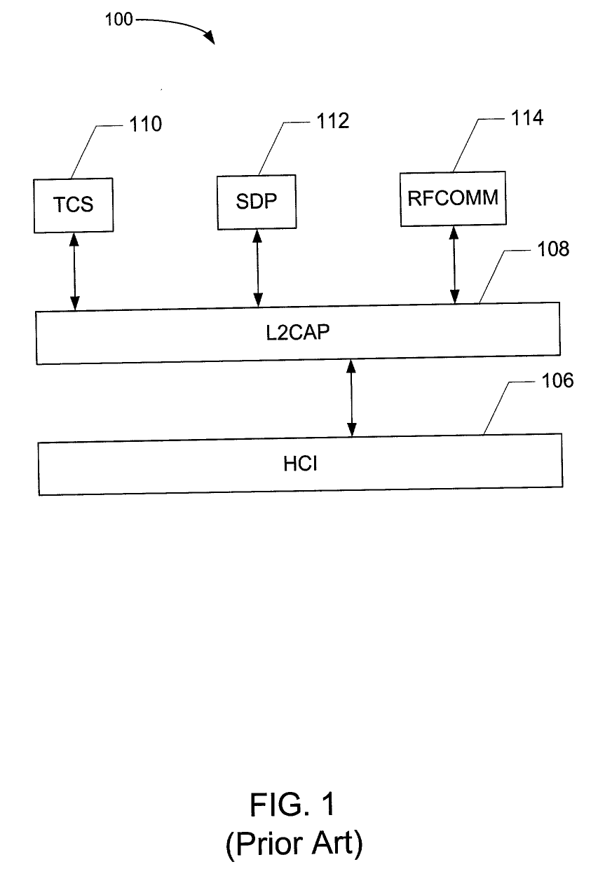

FIG. 2 illustrates a preferred embodiment of a protocol stack which provides stack component instrumentation in accordance with the present invention. The protocol stack 200, in addition to the stack components 106-114 described in conjunction with FIG. 1, comprises a Layer Manager 202 which interfaces with each stack component 106-114. The Layer Manager 202 handles the data flow to the stack components 106-114. The Layer Manager 202 allows each stack component 106-114 to process data without the need to have knowledge of which stack components reside directly “above” and “below” them. Each stack component concerns itself only with whether the data is to travel “up” or “down” the stack 200. Each stack component receives its data from the Layer Manager 202, and when it is done processing the data, it gives the data back to the Layer Manager 202. The Layer Manager 202 then routes the data to the next stack component.

Because the Layer Manager 202 is responsible for the routing of data between stack components 106-114, it also is aware of the stimulus and response of each stack component 106-114. Thus, to instrument the protocol stack 200, the Layer Manager 202 is instrumented without the need to instrument the stack components 102-114. Since the Layer Manager 202 provides a single interface through which all stimuli and responses are passed, the data is captured at a single point and is similar in format. This reduces the amount of code required to capture and analyze the data.

FIG. 3 is a flowchart illustrating a preferred embodiment of a method for providing stack component instrumentation in accordance with the present invention. First, the Layer Manager 202 receives data from a first stack component in the protocol stack 200, via step 302. Next, the Layer Manager 202 analyzes the data for instrumentation information, via step 304. Then, the Layer Manager 202 routes the data to a second stack component, either below or above it, in the protocol stack 200, via step,306.

Although the present invention is described in the context of the Bluetooth protocol stack, it may be applied to the instrumentation of stack components in other protocol stacks without departing from the spirit and scope of the present invention.

An improved method and system for instrumenting protocol stack components has been disclosed. The system comprises a layer manager which interfaces with each stack component and handles the data flow to the stack components. To instrument the protocol stack, the layer manager is instrumented without the need to instrument the stack components. In this manner, the instrumentation of the protocol stack is simplified, and the amount of code required to capture and analyze the data is reduced.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for obtaining instrumentation data in a protocol stack, comprising the steps of:
(a) receiving data from a first stack component of the protocol stack by a layer manager;
(b) analyzing the data for instrumentation information by the layer manager; and
(c) routing the data to a second stack component of the protocol stack by the layer manage

2. The method of claim 1, wherein the layer manager interfaces with each stack component of the protocol stack.

3. The method of claim 1, wherein the layer manager handles data flow to each stack component of the protocol stack.

4. A protocol stack, comprising:
a plurality of stack components; and
a layer manager interfaced with each of the plurality of stack components, wherein the layer manager protocol is instrumented, wherein instrumenting the layer manager instruments the protocol stack.

5. The protocol stack of claim 4, wherein the layer manager handles data flow to each of the plurality of stack components.

6. A computer readable medium with program instructions for obtaining instrumentation data in a protocol stack, comprising the instructions for:
(a) receiving data from a first stack component of the protocol stack by a layer manager;
(b) analyzing the data for instrumentation information by the layer manager; and
(c) routing the data to a second stack component of the protocol stack by the layer manager.

7. The medium of claim 6, further comprising instructions for the layer manager to interface with each stack component of the protocol stack.

8. The medium of claim 6, further comprising instructions for the layer manager to handle data flow to each stack component of the protocol stack.
